(19) United States
(12) Patent Application Publication
(10) Pub. No.: US 2024/0310617 A1
(43) Pub. Date: Sep. 19, 2024

(54) METHOD AND APPARATUS FOR MITIGATING SPECULAR HIGHLIGHTS IN IMAGING OF BIOLOGICAL TISSUE

(71) Applicant: CytoVeris Inc., Farmington, CT (US)

(72) Inventors: David Fournier, Northborough, MA (US); Alan Kersey, South Glastonbury, CT (US)

(21) Appl. No.: 18/575,708

(22) PCT Filed: Jun. 30, 2022
(86) PCT No.: PCT/US2022/035686

§ 371 Date: Dec. 29, 2023

Related U.S. Application Data
(60) Provisional application No. 63/216,862, filed on Jun. 30, 2021.

(51) Int. Cl. G02B 21/16; G01N 21/64; G02B 21/06; G02B 21/36

(52) U.S. Cl. CPC G02B 21/16; G01N 21/6458; G01N 21/6486; G02B 21/06; G02B 21/361

(57) ABSTRACT

A system and method for imaging a tissue sample is provided. The system includes a dome, at least one excitation light source, and at least one light detector. The dome is configured to surround at least a portion of a tissue sample. The dome has interior surfaces that define a dome interior cavity. The excitation light source is configured to produce light at one or more wavelengths. The excitation light source is in photometric communication with the dome. The dome interior surfaces are configured to reflect the light at the one or more predetermined wavelengths. The dome is configured to cause the light at the one or more predetermined wavelengths to be incident to the exposed surface of the tissue sample in a substantially uniform manner. The light detector is in photometric communication with the dome and configured to detect light emitted or reflected from the tissue sample.

This application claims priority to U.S. Patent Appln. No. 63/216,862 filed Jun. 30, 2021, which is hereby incorporated by reference in its entirety.

### BACKGROUND OF THE INVENTION

### 1. Technical Area

The present disclosure relates to multi-spectral imaging systems and methods in general, and to multi-spectral autofluorescence imaging systems and methods configured to address specular highlights in particular.

### 2. Background Information

Fluorescence imaging is an established analytical approach for analysis of cells, tissue structure and disease. Fluorescence microscopy can help investigate biological processes taking place in a living organism [1,2]. For many decades, the reference method for the diagnosis of cancer has been histopathological examination of tissues using conventional microscopy. In surgical pathology, samples can be produced from surgical procedures (tumor resection), diagnostic biopsies or autopsies. These samples go through a process that includes dissection, fixation, and cutting of tissue into precisely thin slices which are stained for contrast and mounted onto glass slides. The slides are subsequently examined by a pathologist under a microscope, and their interpretations of the tissue results in the pathology “read” of the sample.

Tissue autofluorescence (AF) has also been widely developed and has been shown to have potential as a technique for discerning tissue types as well as the presence and progression of cancer in tissue. The biomolecules present in different tissues provide discernible and repeatable autofluorescence [3-5] and reflectance [6] spectral patterns. Intrinsic fluorescence has been utilized with varying degrees of success in assessing margins [7,8]. The endogenous fluorescence signatures offer useful information that can be mapped to the functional, metabolic and morphological attributes of a biological specimen, and have therefore been utilized for diagnostics purposes.

Some existing multi-spectral autofluorescence imaging systems may be configured to illuminate a tissue sample using UV LEDs in a “point source” form, at a near normal incidence to the sample surface. This type of illumination may be satisfactory for the detection of the autofluorescence signatures. However, the detection of the sample reflectivity at different excitation wavelengths may be inhibited/saturated by specular highlights that can occur. Specular highlights are caused by specular reflection in which the angle of incidence is equal to the angle of reflection while a light source and observation point are along the path.

In operation, samples placed into an imaging chamber may be recorded at a variety of “emission” wavebands. Some of these wavebands correspond to the excitation wavelengths, and as such create “in-band” images. These in-band images can be susceptible to specular highlights from tissue surfaces. The specular highlights can dominate portions of the image, saturating some pixels in the camera and therefore not allow adequate reflection measurements in regions containing the specular highlights. Specular highlights occur because specular reflections have a higher intensity than other portions of the image. Reflected light will only occur in a limited range of angles off a surface, where light from a light source hitting the surface happens to reflect into the pupil of the optical system.

The significance of specular reflectance “hot spots” (and the benefit of avoiding them) can be seen in FIGS. 1-3. FIGS. 1 and 2 are white light reflectivity images of two different tissue samples, each showing strong specular reflectance (i.e., photometric “hot spots”). Several of the specular reflectance hot spots shown in FIG. 1 are circled to emphasize their position. The specular reflectance hot spots shown in FIG. 2 are not circled. In the images of FIGS. 1 and 2, the reflected intensity is bright enough to saturate pixels adjacent to the hot spots, which would otherwise only be subject to scattered reflectance. As will be explained hereinafter, FIG. 3 is an image devoid of hot spots created by specular reflectance. Clearly, the difference between an image with specular reflectance hot spots (e.g., FIGS. 1 and 2) and an image devoid of specular reflectance hot spots (e.g., FIG. 3) is striking.

What is needed is a method and apparatus that can overcome tissue sample imaging issues associated with specular reflection.

### SUMMARY

According to an aspect of the present disclosure, a system for imaging a tissue sample is provided that includes a dome, at least one excitation light source, and at least one light detector. The dome is configured to surround at least a portion of a tissue sample. The tissue sample has an exposed surface. The dome has one or more interior surfaces that define an interior cavity of the dome. The at least one excitation light source is configured to produce light at one or more predetermined wavelengths. The at least one excitation light source is in photometric communication with the dome to permit the light produced at the one or more predetermined wavelengths to be passed into the interior cavity of the dome. The one or more interior surfaces are configured to reflect the light at one or more predetermined wavelengths. The dome is configured to cause the light at the one or more predetermined wavelengths to be incident to the exposed surface of the tissue sample in a substantially uniform manner. The at least one light detector is in photometric communication with the dome and configured to detect light emitted from the tissue sample or reflected by the tissue sample.

In any of the aspects or embodiments described above and herein, the dome may include wall portions that comprise a material that reflects the light at one or more predetermined wavelengths, and is photometrically non-reactive to the light at one or more predetermined wavelengths.

In any of the aspects or embodiments described above and herein, the material may be highly reflective of the light at one or more predetermined wavelengths.

In any of the aspects or embodiments described above and herein, the dome may include wall portions that are covered with a coating material that reflects the light at one or more predetermined wavelengths, and is photometrically non-reactive to the light at one or more predetermined wavelengths.

In any of the aspects or embodiments described above and herein, the coating material may be highly reflective of the light at one or more predetermined wavelengths.

In any of the aspects or embodiments described above and herein, the wall portions may be configured to not fluoresce when interrogated with the light at one or more predetermined wavelengths in an amount that would interfere with the imaging of the tissue sample.

In any of the aspects or embodiments described above and herein, the coating material does not fluoresce when interrogated with the light at one or more predetermined wavelengths in an amount that would interfere with the imaging of the tissue sample.

In any of the aspects or embodiments described above and herein, the dome may include wall portions and a layer of material that is attached to the wall portions such that the layer of material defines the one or more interior surfaces that defines the interior cavity of the dome, and wherein the layer of material may be configured to reflect the light at one or more predetermined wavelengths, and is photometrically non-reactive to the light at one or more predetermined wavelengths.

In any of the aspects or embodiments described above and herein, the layer of material may be highly reflective of the light at one or more predetermined wavelengths.

In any of the aspects or embodiments described above and herein, the layer of material does not fluoresce when interrogated with the light at one or more predetermined wavelengths in an amount that would interfere with the imaging of the tissue sample.

In any of the aspects or embodiments described above and herein, the dome may include a base dome section that is configured as a partial sphere, and a top dome section that is configured as a partial sphere.

In any of the aspects or embodiments described above and herein, the base dome section and the top dome section may be releasably attached to one another.

In any of the aspects or embodiments described above and herein, the interior surfaces of the dome may function as a Lambertian surface.

In any of the aspects or embodiments described above and herein, the dome may include a top dome section and a base dome section, and the top dome section includes an imaging light aperture configured to permit light to exit the dome and pass to the at least one light detector, and the base dome section includes a sample aperture configured to receive the tissue sample, and the imaging light aperture is disposed on one side of the dome and the sample aperture is disposed on the opposite side of the dome with the dome interior cavity disposed therebetween.

According to another aspect of the present disclosure a system for imaging a tissue sample is provided that includes a dome, at least one excitation light source, at least one light detector, and a system controller. The dome is configured to enclose at least a portion of a tissue sample, the tissue sample having an exposed surface. The dome has one or more interior surfaces that define an interior cavity of the dome. The at least one excitation light source is configured to produce light at a plurality of predetermined wavelengths. The at least one excitation light source is in photometric communication with the dome to permit the light produced at the plurality of predetermined wavelengths to be passed into the interior cavity of the dome. The dome interior surfaces are configured to reflect the light at the plurality of predetermined wavelengths, and the dome interior surfaces are configured to be photometrically non-reactive to the light at one or more predetermined wavelengths. The dome is configured to cause the light at the plurality of predetermined wavelengths to be incident to the exposed surface of the tissue sample in a substantially uniform manner. The at least one light detector is in photometric communication with the dome and configured to detect light emitted from the tissue sample or reflected by the tissue sample. The system controller is in communication with the at least one excitation light source, the at least one light detector, and a non-transitory memory storing instructions, which instructions when executed cause the system controller to: a) control the at least one excitation light source to sequentially produce excitation light at the plurality of predetermined wavelengths; b) receive and process the signals from the at least one light detector for each sequential application of the plurality of predetermined wavelengths, and produce an image representative of the signals produced by each sequential application of the plurality of predetermined wavelengths; and c) analyze the tissue sample using a plurality of the images to identify a type of the tissue sample.

According to another aspect of the present disclosure, a method for imaging a tissue sample is provided. The method includes: a) using a dome to enclose at least a portion of a tissue sample, the tissue sample having an exposed surface, and the dome having one or more interior surfaces that define an interior cavity of the dome; b) using at least one excitation light source to produce light at one or more predetermined wavelengths, the at least one excitation light source in photometric communication with the dome to permit the light produced at the one or more predetermined wavelengths to be passed into the interior cavity of the dome, wherein the dome interior surfaces are configured to reflect the light at one or more predetermined wavelengths and the dome is configured to cause the light at one or more predetermined wavelengths to be incident to the exposed surface of the tissue sample in a substantially uniform manner; c) using at least one light detector in communication with the dome to detect light emitted from the tissue sample or reflected by the tissue sample; and d) imaging the tissue sample using the detected light.

In any of the aspects or embodiments described above and herein, the dome may include wall portions that are covered with a coating material that reflects the light at one or more predetermined wavelengths, and is photometrically non-reactive to the light at one or more predetermined wavelengths, such that the coating material does not fluoresce when interrogated with the light at one or more predetermined wavelengths in an amount that would interfere with the imaging of the tissue sample.

In any of the aspects or embodiments described above and herein, the dome may include wall portions and a layer of material that is attached to the wall portions such that the layer of material defines the one or more interior surfaces that define the interior cavity of the dome, wherein the layer of material is configured to reflect the light at one or more predetermined wavelengths, and is photometrically non-reactive to the light at one or more predetermined wavelengths.

In any of the aspects or embodiments described above and herein, the layer of material may be photometrically non-reactive to the light at one or more predetermined wavelengths such that the layer of material does not fluoresce when interrogated with the light at one or more predetermined wavelengths in an amount that would interfere with the imaging of the tissue sample. In addition, in any of the aspects or embodiments described above and herein, the imaging step may be based on one or more of a reflection-based measurement, or a fluorescence based measurement, or a Raman spectroscopy measurement, or any combination thereof, and may be used with multi-spectral imaging or hyperspectral imaging.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

FIG. 1 is a white light reflectivity image of a tissue sample with regions of strong spectral reflectance (i.e., photometric “hot spots” indicated by circles).

FIG. 2 is a white light reflectivity image of a tissue sample with regions of strong spectral reflectance.

FIG. 3 is an image of a tissue sample devoid of spectral reflectance hot spots.

FIG. 4 is a diagrammatic representation of a present disclosure system embodiment.

FIG. 5 is a graph of Gray scale values versus distance in pixels.

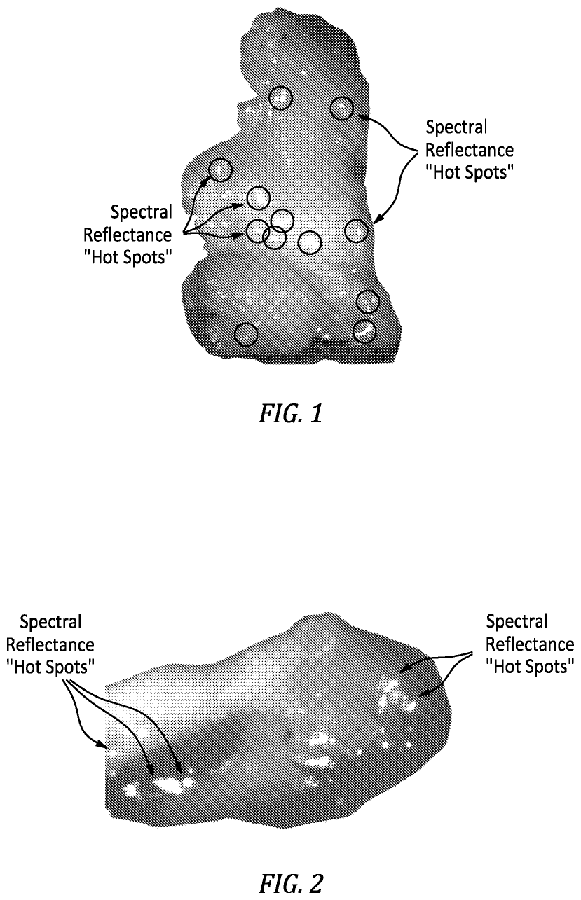

### DISCLOSURE OF THE INVENTION

The advent of ultraviolet light emitting diodes (“UV LEDs”), advancements in UV filter technology, and the emergence of artificial intelligence (AI) have recently enabled exploitation of the rich optical contrast of biomolecular chromophores embedded in tissues. CytoVeris Inc, of Farmington, Connecticut USA, the assignee of the present disclosure, has developed multi-spectral autofluorescence imaging systems [9]. The systems utilize multispectral imaging techniques that include selectively acquiring autofluorescence (AF) signals from significant biomolecules such as collagen, tryptophan, nicotinamide adenine dinucleotide (NADH), flavin adenine dinucleotide (FAD) and the like that may be present within a tissue sample, using multiple excitation and emission filters. Embodiments of the systems use advanced machine learning and artificial intelligence (AI) algorithms on a multispectral dataset to fully exploit the fluorescence information content. The present disclosure system is a rapid and label-free technology that is cost-effective, easy to use, and provides significant technological advancements in surgical and pathological settings.

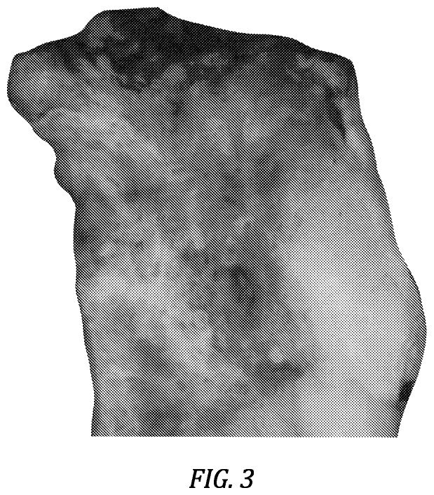

Using the present disclosure system 20, specular highlights caused by illuminating the tissue sample from point sources, including ring lights, above the tissue sample are substantially reduced or eliminated. For example, some embodiments of the present disclosure utilize a randomization of excitation light incident angles and thereby effectively “homogenize” the specular highlights. FIG. 3 is an image of a tissue sample produced using the present disclosure that is clearly devoid of spectral reflectance hot spots.

Embodiments of the present disclosure mitigate or eliminate specular highlights from reflection images without incurring the cost of transmission optics for doing an epi-illumination as is done in reflection microscopes. In epi-illumination, the excitation light and the received light travel substantially the same path, but in opposite directions. Using epi-illumination, very often the only light that can be seen is that from specular reflection. The present disclosure avoids this limitation. In addition, the present disclosure permits the reflection measurement from thick tissue sample.

Embodiments of the present disclosure system 20 utilize “randomized” illumination; e.g., the excitation light within the present disclosure does not come from a limited number of predefined angles, but rather comes from a substantial number of incidence angles and polarization states simultaneously. Consequently, because a substantial number of incidence angles are included in the reflected light, all portions of the image are a product of specular and diffuse reflection. As stated above, specular highlights can dominate an image composed of both specular and diffuse reflection. The present disclosure system 20 avoids this issue and is configured to produce an image having greater uniformity, that mitigates or avoids specular highlights.

A distinct advantage of the present disclosure system 20 is getting a return signal similar to that possible with a high-end microscope with filtering optics, without the need to transmit light (e.g., 280 nm) through an optic. Hence, the present disclosure system 20 is a solution that provides a substantial benefit for short wavelength UV excitation.

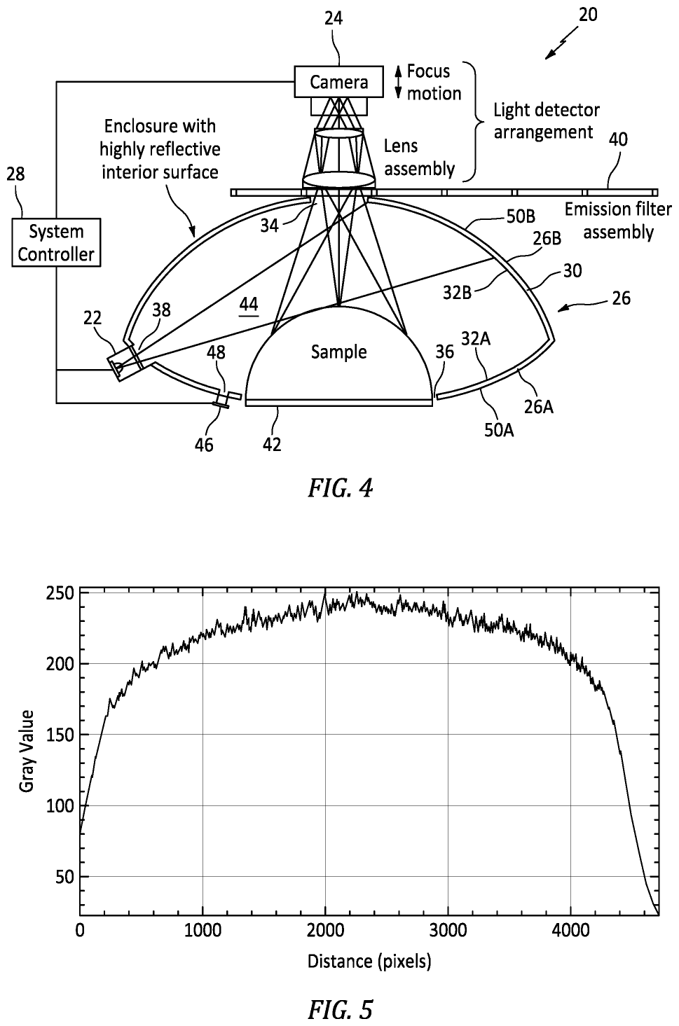

Referring to FIG. 4, the present disclosure system 20 includes an excitation light source 22, at least one light detector 24, a light reflection dome 26, and a system controller 28. In some embodiments, the system 20 may include other components such as one or more optical filters, a filter controller, and the like.

The excitation light source 22 is configured to produce excitation light centered at a plurality of different wavelengths. As will be detailed below, the term “excitation light source” as used herein is refers to a light source configured to produce AF emissions and reflectance light from a tissue specimen interrogated by light. Examples of an acceptable excitation light source 22 include a plurality of light emitting diodes (LEDs) and lasers, each centered at a different wavelength, or a tunable excitation light source 22 configured to selectively produce light centered at respective different wavelengths, or a source of white light (e.g., flash lamps) that may be selectively filtered to produce the aforesaid excitation light centered at respective different wavelengths. This disclosure is not limited to any particular type of excitation light source 22. Stored instructions may be executed by the system controller 28 to control operation of the excitation light source 22; e.g., pursuant to the methodologies and techniques described herein.

The wavelengths produced by the excitation light source 22 are typically chosen based on the photometric properties associated with one or more biomolecules of interest. Excitation light incident to a biomolecule that acts as a fluorophore will cause the fluorophore to emit fluorescent light at a wavelength longer than the wavelength of the excitation light; i.e., via AF. Tissue may naturally include certain fluorophores such as tryptophan, collagen, elastin, nicotinamide adenine dinucleotide (NADH), flavin adenine dinucleotide (FAD), porphyrins, and the like. These properties can be used to differentiate healthy tissues. Biomolecular changes occurring in the cell and tissue state during pathological processes and as a result of disease progression often result in alterations of the amount and distribution of these endogenous fluorophores. Hence, diseased tissues such as cancerous tissue, due to the marked differences in cell-cycle and metabolic activity can exhibit distinct intrinsic tissue AF, or in other words an “AF signature” that is identifiable. Embodiments of the present disclosure may utilize these AF characteristics/signatures to identify regions of diseased tissue such as cancerous tissue as well as different types of healthy tissue. Different types of tissue and diseased tissue of different organs for instance breast and liver cancers may have different biomolecules/biochemicals associated therewith and the present disclosure is not therefore limited to any particular type of healthy tissue, or biomolecule, or any particular type of diseased tissue; e.g., cancerous tissue. Excitation wavelengths are also chosen that cause detectable light reflectance from tissue of interest. The detectable light reflectance includes spectral reflectance and diffuse reflectance. Spectral reflectance refers to incident excitation light that is reflected from surface tissue or near surface tissue of the tissue sample. Diffuse reflectance refers to incident excitation light that passes deeper into the tissue sample (e.g., beyond the near surface tissue) and is reflected or scattered within the tissue. Light subjected to diffuse reflectance is typically attenuated within the tissue. Certain tissue types or permutations thereof may have differing and detectable light reflectance characteristics (“signatures”) at certain wavelengths. Significantly, these reflectance characteristics can provide information beyond intensity; e.g., information relating to cellular or microcellular structure such as cell nucleus and extracellular components. The morphology of a healthy tissue cell may be different from that of an abnormal or diseased tissue cell. Hence, the ability to gather cellular or microstructural morphological information (sometimes referred to as “texture”) provides another tool for determining tissue types and the state and characteristics of such tissue. The excitation light source 22 may be configured to produce light at wavelengths in the ultraviolet (UV) region (e.g., 100-400 nm) and in some applications may include light in the visible region (e.g., 400-700 nm). The excitation lights are typically chosen based on the absorption characteristics of the biomolecules of interest.

The present disclosure may utilize a variety of different light detector types configured to sense light and provide signals that may be used to measure the same. Non-limiting examples of an acceptable light detector 24 include devices that convert light energy into an electrical signal such as photodiodes, avalanche photodiodes, a CCD array, an ICCD, a CMOS, or the like. The at least one light detector 24 may take the form of a camera. As will be described below, the at least one light detector 24 is configured to detect AF emissions from the interrogated tissue, spectral reflectance, and/or diffuse reflectance from the interrogated tissue and produce signals representative of the detected light and communicate the signals to the system controller 28.

The light reflection dome 26 is geometrically configured to surround the tissue sample. In some embodiments, the dome 26 may be configured to geometrically surround the entirety of the tissue sample and in other embodiments the dome 26 may be configured to geometrically surround less than the entirety of the tissue sample; e.g., in the embodiment shown diagrammatically in FIG. 4, the surface of the tissue sample residing on the mounting structure may not be entirely surrounded by (or enclosed within) the dome 26; e.g., the portion of the tissue sample residing on the mounting structure 42 may not be surrounded by the dome 26. In some embodiments, the dome 26 includes one or more wall portions 30, each having an interior surface 32A, 32B. The term “dome” as used herein is not intended to imply any particular geometric configuration other than a geometric configuration that surrounds the tissue sample and is geometrically disposed to facilitate light reflection toward the tissue sample and/or to another portion of the interior surfaces 32A, 32B of the dome. A nonlimiting example of an acceptable dome geometric configuration is one that has a spherical or partial spherical configuration. Another nonlimiting example of an acceptable dome geometric configuration is one having a geodesic configuration. Hence, the wall portion interior surfaces 32A, 32B are geometrically disposed to facilitate light reflection toward the tissue sample and/or to another of the wall portion interior surfaces 32A, 32B.

In some embodiments, the interior surfaces 32A, 32B of the dome walls 30 are highly reflective and photometrically non-reactive to the incident light at the excitation or emission wavelengths. The term “highly reflective” as used herein means that a substantially high percentage of light that is incident to the surface is reflected away from the surface. In preferred embodiments, a “highly reflective” surface of the present disclosure reflects about 90% or more of incident light striking the surface. The term “photometrically non-reactive” as used herein means that the material does not produce a photometric emission (e.g., fluorescence) or other photometric reaction as a result of interrogation by incident light at the excitation or emission wavelengths, or is only photometrically reactive to a degree that is inconsequential to the analysis of the tissue sample.

A dome 26 having interior surfaces 32A, 32B that are highly reflective and photometrically non-reactive may be accomplished in different ways. As a first example, the entire wall portion 30 may be comprised of a material that is highly reflective and photometrically non-reactive. Since the wall material is highly reflective and photometrically non-reactive, the interior surfaces 32A, 32B of the wall portion 30 will also be highly reflective and photometrically non-reactive. As another example, a highly reflective and photometrically non-reactive coating may be applied to the interior surfaces 32A, 32B of the dome walls 30. As another example, a highly reflective and photometrically non-reactive material layer may be attached to the interior surfaces 32A, 32B of the dome walls 30. In these latter two examples, the dome wall may comprise a homogenous material such as a porous polytetrafluoroethylene (PTFE) material that has sufficient mechanical strength to support the coating or the material layer. In these examples, the wall portion material may be configured (e.g., colored throughout, or painted, etc.) to be photometrically non-reactive to ensure that any excitation light that may strike the wall portion 30 material does not produce an unwanted photometric reaction such as fluorescence. In yet another example, a highly reflective and photometrically non-reactive material layer may be supported in a dome-like shape; e.g., by a skeletal structure or the like. This embodiment may have the advantage of easy replacement of the highly reflective and photometrically non-reactive material layer should that be necessary.

The dome 26 may be a rigid structure or a flexible structure that can assume the dome configuration. The dome 26 may have a geometry that has a fixed volume interior cavity 44, or it may be configured to be adjustable so that the volume of the interior cavity 44 can be increased or decreased to suit the needs of the application.

In some embodiments, the dome 26 may include a plurality of apertures, including at least one imaging light aperture 34, at least one sample aperture 36, and at least one emitted light aperture 38. The imaging light aperture 34 is disposed and configured to permit light to exit the dome 26 and pass through to an emission/reflectance light filter assembly 40 and a light detector 24 arrangement; i.e., the imaging light aperture 34 is configured so that the emission/reflectance light filter assembly 40 and a light detector 24 arrangement are in photometric communication with the interior of the dome 26. The sample aperture 36 is disposed and configured to receive a tissue sample disposed on a mounting structure 42 and permit at least a portion of the tissue sample to be disposed in an interior cavity 44 of the dome 26. In some embodiments, the imaging light aperture 34 is disposed on one side of the dome 26 and the sample aperture 36 is disposed on the opposite side of the dome 26 with the dome interior cavity 44 disposed therebetween; e.g., the imaging light aperture 34 is disposed vertically above the sample aperture 36. The at least one emitted light aperture 38 is aligned with the excitation light source 22 and configured to permit light emitted from the excitation light source 22 to enter the dome 26; i.e., the emitted light aperture 38 is configured so that the excitation light source is in photometric communication with the interior of the dome 26. In system embodiments wherein there is more than one excitation light source 22 or portions of the excitation light source 22 are separately positioned (e.g., LEDs disposed at different positions relative to the dome 26), each respective emitted light aperture 38 is aligned with a respective excitation light source 22. In some embodiments (as shown in FIG. 4 and described herein), the system 20 may include a reference light detector 46. In those embodiments, the dome 26 includes an aperture (“reference light aperture 48”) that permits light to exit the dome 26 and pass through to the reference light detector 46; i.e., the reflectance light aperture 48 is configured so that the reference light detector 46 is in photometric communication with the interior of the dome 26. Other than the aforesaid apertures, the dome 26 is configured to enclose the tissue sample in a manner such that any light emitted or reflected from the tissue sample will either strike the dome 26 or will pass through the imaging light aperture 34 or the reference light aperture 48. In some embodiments, the aforesaid apertures (i.e., the imaging light aperture 34, the emitted light aperture 38, and the reference light aperture 48) may be void of material (e.g., openings in the dome). In alternative embodiments, the aforesaid apertures may be portions of the dome that permit like to pass through substantially unimpeded; e.g., photometrically translucent to a degree that any amount of light that may be impeded passing through the respective translucent material is inconsequential and does not affect the imaging function of system 20.

In some embodiments, light passage into or out of the dome 26 may be accomplished using a light pipe (e.g., a fiber optic or the like) rather than an open aperture that allows light to pass through the respective wall light reflective portion.

The system controller 28 is in communication with other components within the system 20, such as the excitation light source 22 and the at least one light detector 24. In some system 20 embodiments, the system 20 may also be in communication with other components such as a filter controller, a tunable optical filtering device, and the like as will be described below. The system controller 28 may be in communication with these components to control and/or receive signals therefrom to perform the functions described herein. The system controller 28 may include any type of computing device, computational circuit, processor(s), CPU, computer, or the like capable of executing a series of instructions that are stored in memory. The instructions may include an operating system, and/or executable software modules such as program files, system data, buffers, drivers, utilities, and the like. The executable instructions may apply to any functionality described herein to enable the system 20 to accomplish the same algorithmically and/or coordination of system components. The system controller 28 includes or is in communication with one or more memory devices. The present disclosure is not limited to any particular type of memory device, and the memory device may store instructions and/or data in a non-transitory manner. Examples of memory devices that may be used include read-only memory, random access memory, volatile memory, non-volatile memory, static memory, dynamic memory, flash memory, cache memory, and/or any device that stores digital information. The system controller 28 may include, or may be in communication with, an input device that enables a user to enter data and/or instructions, and may include, or be in communication with, an output device configured, for example to display information (e.g., a visual display or a printer), or to transfer data, etc. Communications between the system controller 28 and other system components may be via a hardwire connection or via a wireless connection.

Some embodiments of the present disclosure may include optical filtering elements configured to filter excitation light, or optical filtering elements configured to filter emitted light (including reflected light; e.g., emission filter assembly 40), or both. Each optical filtering element is configured to pass a defined bandpass of wavelengths associated with an excitation light source 22 or emitted/reflected light (e.g., fluorescence or reflectance), and may take the form of a bandpass filter. In regard to filtering excitation light, the system 20 may include an independent filtering element associated with each independent excitation light source 22 or may include a plurality of filtering elements disposed in a movable form (e.g., a wheel or a linear array configuration) or may include a single filtering element that is operable to filter excitation light at a plurality of different wavelengths, or each excitation light source 22 may be configured to include a filtering element (e.g., a material coating applied to the light source configured to allow desired bandpass), or the like. In regard to filtering emitted light, the system 20 may include a plurality of independent filtering elements each associated with a different bandwidth or may include a plurality of filtering elements disposed in a movable form or may include a single filtering element that is operable to filter emitted/reflected light at a plurality of different wavelengths (e.g., tunable), or the like. The bandwidth of the emitted/reflected light filters are typically chosen based on the photometric properties associated with one or more biomolecules of interest. Certain biomolecules may have multiple emission or reflectance peaks. The bandwidth of the emitted/reflected light filters may be chosen to allow only emitted/reflected light from a limited portion of the biomolecule emission/reflectance response; i.e., a portion of interest that facilitates the analysis described herein.

The present disclosure system 20 may be implemented in a variety of different embodiments and configurations. An exemplary embodiment of a present disclosure system 20 is diagrammatically illustrated in FIG. 4 to illustrate the utility of the present disclosure system 20. The present disclosure system 20 is not limited to the embodiment shown in FIG. 4.

The system 20 embodiment shown in FIG. 4 includes a dome 26, an excitation light source 22, an emission/reflectance light filter assembly, a light detector 24 arrangement, and a system controller 28. In this embodiment, the light detector 24 arrangement includes a camera and a lens assembly. The camera may be vertically translatable for purposes of focusing. The tissue sample is mounted on a mounting structure 42 such as a microscope slide and may include a coverslip (not shown) disposed on a surface opposite that in contact with the mounting structure. The mounting structure 42 (and coverslip when included) are configured with a material that does not interfere with the spectrophotometric analysis process of the tissue sample; e.g., excitation light incident to the mounting structure 42 does not produce any photometric emissions (e.g., fluorescence, etc.) from the mounting structure 42 that may interfere with the photometric analysis process of the tissue sample.

The dome 26 is geometrically configured to substantially surround the tissue sample. The diagrammatic view shown in FIG. 4 is two-dimensional, but the dome 26 would be three-dimensional. In the embodiment shown in FIG. 4, the dome 26 may be described as having a base dome section 26A and a top dome section 26B. The embodiment shown in FIG. 4 represents a nonlimiting example of a dome 26 configuration. Alternative dome 26 configurations are described above. The base dome section 26A is defined by a wall portion 30 having an interior surface 32A and an exterior surface 50A. The top dome section 26B is defined by a wall portion 30 having an interior surface 32B and an exterior surface 50B. The dome 26 may be a unitary structure wherein the base dome section 26A and the top dome section 26B are attached (e.g., bonded) to one another, or are formed together using a process such as three-dimensional printing. Alternatively, the base and top dome sections 26A, 26B may be independent structures that are releasably attachable to one another by mechanical fasteners or the like. In these multi-section embodiments, the joint between the base and top dome sections 26A, 26B is preferably photometrically “sealed” to prevent the entry of ambient light into the interior cavity 44 of the dome 26 and/or to prevent the exit of light from the interior cavity 44. The base dome section 26A is configured as a partial-sphere; i.e., the base dome section wall portions curve upwardly to meet the top dome section wall portions. The partial-sphere shape is truncated at the lower edge which defines an aperture (e.g., a “sample aperture 36”) configured to receive a tissue sample disposed on a mounting structure 42 and thereby permit the tissue sample to be disposed in an interior cavity 44 of the dome 26. The top dome section 26B is also configured as a partial-sphere; i.e., the top dome section wall portions curve downwardly to meet the base dome section wall portions. The partial-sphere shape of the top dome section 26B is truncated at the upper edge which defines an aperture configured to permit light to exit the dome 26 via an aperture (e.g., the “imaging light aperture 34”) and pass through to the emission/reflectance light filter assembly 40 and the light detector 24 arrangement. The partial-sphere geometric configuration of the base and top dome sections 26A, 26B is a non-limiting example of a geometric configuration that can be used. In the embodiment shown in FIG. 4, the imaging light aperture 34 is disposed on one side of the dome 26 and the sample aperture 36 is disposed on the opposite side of the dome 26 with the dome interior cavity 44 disposed therebetween; e.g., the imaging light aperture 34 is disposed vertically above the sample aperture 36. As indicated above, the base and top dome sections 26A, 26B have an interior surface 32A, 32B that is highly reflective and photometrically non-reactive. Various embodiments for producing interior surfaces 32A, 32B that are highly reflective and photometrically non-reactive are described above.

In the embodiment shown diagrammatically in FIG. 4, the dome 26 includes an imaging light aperture 34, an emitted light aperture 38, and a reference light aperture 48. The imaging light aperture 34 permits light to exit the dome 26 and pass through to the emission/reflectance light filter assembly 40 and the light detector 24 arrangement; i.e., the imaging light aperture 34 is configured so that the emission/reflectance light filter assembly 40 and a light detector 24 arrangement are in photometric communication with the interior of the dome 26. The emitted light aperture 38 is aligned with an excitation light source 22 to permit light emitted from the light source 22 to enter the dome 26; i.e., the emitted light aperture 38 is configured so that the excitation light source is in photometric communication with the interior of the dome 26. As indicated above, embodiments of the present disclosure may include a plurality of light sources (e.g., different LEDs, each configured to emit light at a different wavelength, etc.) and the dome 26 may include an emitted light aperture 38 for each respective light source 22. The reference light aperture 48 permits light to exit the dome 26 and pass through to the reference light detector 46; i.e., the reference light aperture 48 is configured so that the reference light detector 46 is in photometric communication with the interior of the dome 26. The reference light detector 46 may be used to measure power density and input all the illumination wavelengths desired within the imaging process.

In the operation of the system 20 embodiment diagrammatically shown in FIG. 4, an excised tissue sample may be placed on a mounting structure 42 (e.g., a glass slide). The mounted sample is then disposed such that at least a portion of the tissue sample is disposed within the interior cavity 44 of the dome 26.

Instructions stored within the system controller 28 are executed to cause the system controller 28 to control the excitation light source 22 to produce excitation light at a plurality of different predetermined wavelengths; e.g., by operating multiple independent LEDs, or a wavelength controllable light source, or by operating a white light source with appropriate filtration to produce the predetermined wavelengths. The excitation light passes into the light reflective dome 26 through the emitted light aperture 38. The excitation light source 22 may be oriented at a variety of different angles relative to the tissue sample. For example, in FIG. 4 light produced by the excitation light source 22 is directed at an angle that is not normal to the tissue sample. The divergent light emanating from the excitation light source 22 (e.g., a plurality of LEDs each at a given wavelength—LED1, LED2 . . . . LEDn) strikes the highly reflective surface 32A, 32B of the dome 26 and creates a substantially uniform light source above the tissue sample that is ultimately directed toward the tissue sample. In embodiments wherein the excitation light source 22 includes a plurality of light sources (e.g., a plurality of LEDs), the aforesaid individual light sources may be configured so that the produced light overlaps at numerous points (e.g., about 50% of points) to increase the uniformity of the light incident to the sample.

More specifically, light emitted into the dome 26 (depending on the initial incidence angle) will strike the highly reflective interior surface 32A, 32B of the dome 26. The light striking the highly reflective interior surface 32A, 32B of the dome 26 will either reflect and again strike the highly reflective interior surface 32A, 32B or will reflect and interrogate the tissue sample. A small amount of the light striking the highly reflective interior surface 32A, 32B of the dome 26 may be absorbed by the dome 26. Light interrogating the tissue sample may excite a biomolecule to produce an AF emission, or may reflect off of the surface or near-surface tissue of the tissue specimen, or may penetrate deeper into the specimen and produce diffuse reflectance. Light reflected from or emitted out of the tissue specimen may travel in a direction wherein it strikes the highly reflective interior surface 32A, 32B of the dome 26, or may pass through the imaging light aperture 34. In those embodiments that include an emission filter assembly 40, the light passing through the imaging light aperture 34 will pass through a filtering element of the emission filter assembly 40 prior to encountering the camera. The camera, in turn, senses the now filtered light and produces signals representative thereof which are communicated to the system controller 28 for processing. Light reflected from or emitted out of the tissue specimen that strikes the highly reflective interior surface 32A, 32B of the dome 26 will randomly continue to be reflected within the dome 26, or will find its way to the camera via the imaging light aperture 34, or will once again be incident to the tissue sample, or may be absorbed. The result of the light reflection within the dome 26 is a uniformity of incident light to the sample as opposed to a direct point application of excitation light that is often used in existing systems. The highly reflective interior surface 32A, 32B of the dome 26 diffuses the light from the excitation light source 22 (e.g., the highly reflective interior surface 32A, 32B of the dome 26 functions as a Lambertian surface, producing a Lambertian reflectance) that ensures that the light emanating from the tissue sample does not have reflectance “hot spots” and effectively illuminates the tissue sample at a broad range of angles. Light that does not hit the sample may hit a reflective surface on the bottom portion of dome 26 and reflect upward to the reflecting surface above and continue reflecting off surfaces until it either absorbed into the dome 26 material or finds its way to the tissue sample. The uniformity of incident light to the sample increases the uniformity of light emanating from the tissue sample (e.g., via AF emission of reflectance) that avoids or significantly mitigates reflectance “hot spots” that would otherwise be produced. FIG. 5 is a graph of Gray scale values versus distance (in pixels), illustrating uniformity of sample illumination over a camera field of view using the present disclosure system 20.

The present disclosure system 20 is not restricted to AF or reflectance measurement. Embodiments of the present disclosure system 20 may be utilized for multi-spectral or hyperspectral imaging systems for diagnostic and/or visualization purposes.

Some embodiments of the present disclosure system 20 may utilize filters that reflect light at wavelengths other than the transmission wavelengths. In these embodiments, any apertures in the structure that contain filters do not significantly reduce the reflecting capability (efficiency) of the structure.

Specular highlights may also be mitigated or eliminated by only illuminating the sample within a numerical aperture that the received light will see (e.g., epi-illumination; similar to a reflection microscope). However, for illuminating with light at a wavelength such as 280 nm, there are relatively few glasses that will efficiently transmit that wavelength of light.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

### REFERENCES

1. E. A. Specht et al., “A Critical and Comparative Review of Fluorescent Tools for Live-Cell Imaging”, Annu. Rev. Physiol., 79:93-117, 2017.
2. M. J. Sanderson et al., “Fluorescence Microscopy”, Cold Spring Harb Protoc.; (10), 201.
3. A. C. Croce, G. Bottiroli, Autofluorescence spectroscopy and imaging: a tool for biomedical research and diagnosis. Eur J Histochem 58, 2461-2461 (2014).
4. W. Zheng, W. Lau, C. Cheng, K. C. Soo, M. Olivo, Optimal excitation-emission wavelengths for autofluorescence diagnosis of bladder tumors. Int J Cancer 104, 477-481 (2003).
5. M. Marsden et al., Intraoperative Margin Assessment in Oral and Oropharyngeal Cancer Using Label-Free Fluorescence Lifetime Imaging and Machine Learning. IEEE Transactions on Biomedical Engineering 68, 857-868 (2021).
6. Dhär et al., “A diffuse reflectance spectral imaging system for tumor margin assessment using custom annular photodiode arrays”, Biomedical Optics Express, 3, (12), 2012.
7. M. Keller et al., “Autofluorescence and diffuse reflectance spectroscopy and spectral imaging for breast surgical margin analysis”, Lasers in Surgery and Medicine, Wiley Online Library, Jan. 13, 2010.
8. J. Unger et al. “Real-time diagnosis and visualization of tumor margins in excised breast specimens using fluorescence lifetime imaging and machine learning”, Biometical Optics Express, Vol. 11, Issue 3, pp. 1216-1230 (2020)
9. D. Fournier and R. Pandey “Multi-Spectral imager for UV based Tissue Autofluoresence Mapping”, U.S. Patent Application No. 63/079,783.

1. A system for imaging a tissue sample, comprising:
a dome configured to surround at least a portion of a tissue sample, the tissue sample having an exposed surface, and the dome having one or more interior surfaces that define an interior cavity of the dome;
at least one excitation light source configured to produce light at one or more predetermined wavelengths, the at least one excitation light source in photometric communication with the dome to permit the light produced at the one or more predetermined wavelengths to be passed into the interior cavity of the dome;
wherein the one or more interior surfaces are configured to reflect the light at the one or more predetermined wavelengths, wherein the interior surface materials of the dome are photometrically nonreactive and highly reflective of the light at one or more predetermined wavelengths and the dome is configured to cause the light at the one or more predetermined wavelengths to be incident to the exposed surface of the tissue sample in a substantially uniform manner; and
at least one light detector in photometric communication with the dome and configured to detect light emitted from the tissue sample or reflected by the tissue sample; and
wherein the one or more interior surfaces of the dome do not fluoresce when interrogated with the light at the one or more predetermined wavelengths in an amount that would interfere with the imaging of the tissue sample.

2-7. (canceled)

8. The system of claim 1, wherein the dome includes wall portions and a layer of material that is attached to the wall portions such that the layer of material defines the one or more interior surfaces that defines the interior cavity of the dome, wherein the layer of material is configured to reflect the light at one or more predetermined wavelengths, and is photometrically non-reactive to the light at one or more predetermined wavelengths.

9. The system of claim 8, wherein the layer of material is highly reflective of the light at one or more predetermined wavelengths.

10. The system of claim 8, wherein the wall portions are configured to not fluoresce when interrogated with the light at one or more predetermined wavelengths in an amount that would interfere with the imaging of the tissue sample.

11. The system of claim 8, wherein the layer of material does not fluoresce when interrogated with the light at one or more predetermined wavelengths in an amount that would interfere with the imaging of the tissue sample.

12. The system of claim 1, wherein the dome includes a base dome section that is configured as a partial sphere, and a top dome section that is configured as a partial sphere.

13. The system of claim 12, wherein the base dome section and the top dome section are releasably attached to one another.

14. The system of claim 1, wherein the interior surfaces of the dome function as a Lambertian surface.

15. The system of claim 1, wherein the dome includes a top dome section and a base dome section, and the top dome section includes an imaging light aperture configured to permit light to exit the dome and pass to the at least one light detector; and
wherein the base dome section includes a sample aperture configured to receive the tissue sample; and
wherein the imaging light aperture is disposed on one side of the dome and the sample aperture is disposed on the opposite side of the dome with the dome interior cavity disposed therebetween.

16. A system for imaging a tissue sample, comprising:
a dome configured to enclose at least a portion of a tissue sample, the tissue sample having an exposed surface, and the dome having one or more interior surfaces that define an interior cavity of the dome;
at least one excitation light source configured to produce light at a plurality of predetermined wavelengths, the at least one excitation light source in photometric communication with the dome to permit the light produced at the plurality of predetermined wavelengths to be passed into the interior cavity of the dome;
wherein the dome interior surfaces are configured to reflect the light at the plurality of predetermined wavelengths, and the dome interior surfaces are configured to be photometrically non-reactive to the light at one or more predetermined wavelengths, and the dome is configured to cause the light at the plurality of predetermined wavelengths to be incident to the exposed surface of the tissue sample in a substantially uniform manner;
at least one light detector in photometric communication with the dome and configured to detect light emitted from the tissue sample or reflected by the tissue sample; and
a system controller in communication with the at least one excitation light source, the at least one light detector, and a non-transitory memory storing instructions, which instructions when executed cause the system controller to:
control the at least one excitation light source to sequentially produce excitation light at the plurality of predetermined wavelengths;
receive and process the signals from the at least one light detector for each sequential application of the plurality of predetermined wavelengths, and produce an image representative of the signals produced by each sequential application of the plurality of predetermined wavelengths; and
analyze the tissue sample using a plurality of the images to identify a type of the tissue sample.

17. A method for imaging a tissue sample, comprising:
using a dome to enclose at least a portion of a tissue sample, the tissue sample having an exposed surface, and the dome having one or more interior surfaces that define an interior cavity of the dome;
using at least one excitation light source to produce light at one or more predetermined wavelengths, the at least one excitation light source in photometric communication with the dome to permit the light produced at the one or more predetermined wavelengths to be passed into the interior cavity of the dome;
wherein the dome interior surfaces are configured to reflect the light at one or more predetermined wavelengths and the dome is configured to cause the light at one or more predetermined wavelengths to be incident to the exposed surface of the tissue sample in a substantially uniform manner; and
using at least one light detector in communication with the dome to detect light emitted from the tissue sample or reflected by the tissue sample; and
imaging the tissue sample using the detected light.

18. The method of claim 17, wherein the dome includes wall portions that are covered with a coating material that reflects the light at one or more predetermined wavelengths, and is photometrically non-reactive to the light at one or more predetermined wavelengths, such that the coating material does not fluoresce when interrogated with the light at one or more predetermined wavelengths in an amount that would interfere with the imaging of the tissue sample.

19. The method of claim 17, wherein the dome includes wall portions and a layer of material that is attached to the wall portions such that the layer of material defines the one or more interior surfaces that define the interior cavity of the dome, wherein the layer of material is configured to reflect the light at one or more predetermined wavelengths, and is photometrically non-reactive to the light at one or more predetermined wavelengths.

20. The method of claim 17, wherein the layer of material is photometrically inactive to the light at one or more predetermined wavelengths such that the layer of material does not fluoresce when interrogated with the light at one or more predetermined wavelengths in an amount that would interfere with the imaging of the tissue sample.

21. The method of claim 17, wherein the imaging step is based on one or more of a reflection-based measurement, or a fluorescence based measurement, or a Raman spectroscopy measurement, or any combination thereof.
